(19) United States
(12) Patent Application Publication
(10) Pub. No.: US 2007/0293710 A1
(43) Pub. Date: Dec. 20, 2007

(54) Catalyst For Olefin Polymerization Including Phenoxy Ligand And Method Of (Co) Polymerization Of Olefin Using Same

(75) Inventors: Eun-Il Kim, Daejeon (KR); Ho-Sik Chang, Daejeon (KR)

Correspondence Address: BARLOW, JOSEPHS & HOLMES, LTD., 101 DYER STREET, 5TH FLOOR, PROVIDENCE, RI, 02903, US

(73) Assignee: SAMSUNG TOTAL PETROCHEMICALS CO., LTD., Chungcheongnam (KR)

(21) Appl. No.: 11/575,390

(22) PCT Filed: Mar. 31, 2005
(86) PCT No.: PCT/KR05/00943

§ 371 Date: Jun. 27, 2007

(30) Foreign Application Priority Data
Sep. 23, 2004 (KR) 10-2004-0076251

(51) Int. Cl. C08F 4/64; B01J 31/02

(52) U.S. Cl. 585/500; 502/171

(57) ABSTRACT

The present invention provides a Ziegler-Natta catalyst for olefin polymerization comprising transition metal compound containing aryloxy ligand and transition metal with the oxidation number of 3 from Group IV, V or VI of the Periodic Table of Elements which is prepared by the reduction of transition metal compound containing at least two aryloxy ligands and transition metal with the oxidation number of 4 or more from Group IV, V or VI of the Periodic Table, and an olefin (co)polymerization method using the same as a main catalyst. According to the present invention, it is possible to provide a Ziegler-Natta catalyst for olefin polymerization having high polymerization activity, as compared with conventional catalysts of transition metal compounds comprising transition metal compound containing transition metal with the oxidation number of 3, and a method for preparing olefin (co)polymer having broad molecular weight distribution by using the same with high activity.

### TECHNICAL FIELD

The present invention relates to a Ziegler-Natta catalyst for olefin polymerization comprising transition metal compound containing aryloxy ligand and transition metal with the oxidation number of 3 from Group IV, V or VI of the Periodic Table of Elements which is prepared by the reduction of transition metal compound containing at least two aryloxy ligands and transition metal with the oxidation number of 4 or more from Group IV, V or VI of the Periodic Table, and to an olefin (co)polymerization method using the same as a main catalyst.

### BACKGROUND ART

Regarding olefin polymerization wherein transition metal compound is used as a main catalyst, a method for preparing ethylene (co)polymers by using transition metal compound containing transition metal with the oxidation number of 3 from Group IV of the Periodic Table of Elements is disclosed in U.S. Pat. No. 4,894,424. In said US patent, a catalyst is prepared by the reduction of a transition metal compound containing transition metal with the oxidation number of at least 4 from Group IV, V or VI of the Periodic Table such as a titanium compound represented by Ti(OR)ₘClₙ (wherein, n+m=4), with Grignard compound represented by RMgCl(wherein, R is an alkyl group) obtained from magnesium (Mg) and alkyl chloride(RCl). Since the catalyst is prepared by the reductive reaction using Grignard compound, 80% or more of titanium contained in the catalyst is present in the oxidation state of 3, i.e. as Ti³⁺. Said U.S. Pat. No. 4,894,424 uses an alkoxy ligand as a ligand being introduced into the titanium compound.

Recently, aryloxy compounds such as phenoxy compounds have been used mainly in non-metallocene catalysts. With respect to this, some researches have been reported. For example, J. Am. Chem. Soc. Vol. 117, p. 3008 discloses a catalyst for olefin polymerization using a compound prepared by combining 1,1′-bi-2,2′-naphthol as a ligand to transition metal such as Ti or Zr, or derivatives thereof, and Japanese laid-open patent publication Heisei 6-340711 and EP No. 0606125 A2 disclose a chelated catalyst for olefin polymerization wherein halide ligand of titan halides and zirconium halides is replaced with chelated phenoxy groups, which can produce polymers having high molecular weight and narrow molecular weight distribution. Further, Macro-molecules, vol. 15, p. 5069, and vol. 30, p. 1562 disclose a catalyst system for ethylene polymerization which uses titanium compound having bisphenol ligand as a main catalyst, and MAO as a co-catalyst.

### DISCLOSURE OF INVENTION

### Technical Problem

However, the above-mentioned non-metallocene catalysts for olefin polymerization comprising chelated titanium or zirconium compounds have a problem of using expensive MAO or boron compounds as a cocatalyst, and they have limited range of applications since it is limited to the structure where two phenoxy groups are connected each other.

On the other hand, Organometallics, vol. 17, p. 3138 and vol. 18, p. 2557 report the examples of synthesis of compounds where titanium halides are substituted with two-molecules of phenoxy compounds and the use thereof as a catalyst for Diels-Alder reaction. However, there is no report on a Ziegler-Natta catalyst for olefin polymerization wherein two molecules of aryloxy compounds such as phenoxy compounds are chelated.

### Technical Solution

The present invention is to provide a novel Ziegler-Natta catalyst system for olefin polymerization and a method using thereof for preparing olefin (co)polymers having broad molecular weight distribution with high polymerization activity, as compared with methods using a conventional catalyst of transition metal compound having transition metal with the oxidation number of 3 from Group IV of the Periodic Table. The catalyst according to the present invention is obtained by introducing aryloxy ligand(s), which have been merely used in the preparation of catalyst for Diels-Alder reaction in conventional methods, into transition metal compound having transition metal with the oxidation number of 4 or more, and reducing the resulted compound with organomagnesium compound.

### MODE FOR THE INVENTION

According to the present invention, provided is a Ziegler-Natta catalyst for olefin polymerization comprising transition metal compound containing aryloxy ligand and transition metal with the oxidation number of 3 from Group IV, V or VI of the Periodic Table of Elements which is prepared by the reduction of transition metal compound containing at least two aryloxy ligands and transition metal with the oxidation number of 4 or more from Group IV, V or VI of the Periodic Table.

The transition metal compound containing aryloxy ligand and transition metal with the oxidation number of 3 from Group IV, V or VI of the Periodic Table of Elements used for the Ziegler-Natta catalyst of the present invention can be prepared by the reduction of transition metal compound containing at least two aryloxy ligands and transition metal with the oxidation number of 4 or more from Group IV, V or VI of the Periodic Table, represented by the formula of M(OAr)ₙXₐ₋ₙ (wherein M is a transition metal from Group IV, V or VI of the Periodic Table; Ar is a substituted or non-substituted aryl group having C6-C30; X is a halogen atom; n is an integer or a fraction satisfying 2≦n≦a; and a is the oxidation number of M and an integer of 4 or more), with organomagnesium compound, as represented by the following reaction scheme 1 as an example.
Ti(OAr)ₙCl₄₋ₙ+RMgX→Ti(OAr)ₙ₋₁Cl₄₋ₙ [reaction scheme 1]

In the reaction scheme 1, Ar is a substituted or non-substituted aryl group having C6-C30; R is an alkyl group having C1-C16; X is a halogen atom; and n is an integer or a fraction satisfying 2≦n≦4.

As for the transition metal from Group IV, V or VI of the Periodic Table used in the Ziegler-Natta catalyst of the present invention, among known transition metals conventionally used for a Zeigler-Natta catalyst, the transition metals which can be reduced by organomagnesium compounds may be used, and preferably used is titanium.

In the Ziegler-Natta catalyst according to the present invention, for the introduction of aryloxy ligands into the transition metal compound, substituted or non-substituted phenoxy compounds having C6-C30 such as 2,6-diisopropylphenol, 2-methyl-6-butylphenol, 2-butyl-6-butylphenol and the like may be used, and among those, preferably used is 2,6-diisopropylphenol.

The organomagnesium compound used in the preparation of a Ziegler-Natta catalyst of the present invention is represented by the formula of RₘMgX₂₋ₘ (wherein R is an alkyl having C1-C16; X is a halogen atom; m is an integer or a fraction satisfying 0<m≦2).

According to one preferred embodiment of the present invention, the Ziegler-Natta catalyst for olefin polymerization of the present invention can be prepared by the following method.

Firstly, the transition metal compound containing at least two aryloxy ligands and transition metal with the oxidation number of 4 or more from Group IV, V or VI of the Periodic Table, can be prepared by, for example, reacting excessive amount of phenoxy compounds with titanium tetrachloride in the presence of n-butyl lithium.

The transition metal compound containing aryloxy ligand and transition metal with the oxidation number of 3 from Group IV, V or VI of the Periodic Table of Elements used for the Ziegler-Natta catalyst of the present invention may be prepared by reducing a transition metal compound containing at least two aryloxy ligands and transition metal with the oxidation number of 4 or more from Group IV, V or VI of the Periodic Table, with an organomagnesium compound at the temperature of −20-150° C., preferably 60-90° C., in the presence of aliphatic hydrocarbons such as heptane, and optionally an electron donor such as tetrahydrofuran, ether and the like.

The aliphatic hydrocarbons useful in the present invention may include hexane, heptane, propane, isobutane, octane, decane, kerosene and the like, and particularly preferred is hexane or heptane. The electron donor useful in the present invention may include methyl formate, ethyl acetate, butyl acetate, ethyl ether, tetrahydrofuran, dioxane, acetone, methyl ethyl ketone and the like, and particularly preferred is tetrahydrofuran.

The reduction of the transition metal compound containing at least two aryloxy ligands and transition metal with the oxidation number of 4 or more from Group IV, V or VI with organomagnesium compounds, is carried out preferably in the presence of an alkyl halide having an alkyl group of C1-C16.

The organomagnesium compound used as a reducing agent is represented by the formula of RMgX or MgR₂, (wherein R is an alkyl group having C1-C16 and X is a halogen atom) and can be prepared in advance and then applied to the reaction with the transition metal compound containing at least two aryloxy ligands and transition metal with the oxidation number of 4 or more. Further, the organomagnesium compound can be used in the form of a complex with a solvent being used or optionally with an electron donor such as ether.

In the preparation of the catalyst of the present invention, above compounds are preferably used in the molar ratio as given below, in terms of efficiency in the catalyst production process and improvement in polymerization activity:

0.1≦(the transition compound containing at least two aryloxy ligands/RMgX)≦0.5, and 1≦alkyl halide/RMgX≦2; or

0.1≦(the transition compound containing at least two aryloxy ligands/MgR₂)≦0.5, and 2≦alkyl halide/MgR₂≦4.

According to another embodiment of the present invention, the catalyst of the present invention can be prepared, while the preparation of an organomagnesium compound is not carried out in advance, from magnesium metal, the transition metal compound containing at least two aryloxy ligands and transition metal with the oxidation number of 4 or more from Group IV, V or VI, and alkyl halide, in the presence of an aliphatic hydrocarbon and/or electron donor, at the temperature of −20° C.-150° C., preferably 60° C.-90° C. In this case, it is understood that the reducing agent, organomagnesium compound, is produced during the catalyst preparation reaction and, as being produced, simultaneously reacts with the transition compound containing at least two aryloxy ligands. In this embodiment, the compounds are preferably used in the molar ratio as represented below, in terms of efficiency in the catalyst production process and improvement in polymerization activity:

0.1≦(the transition compound containing at least two aryloxy ligands/Mg)≦0.5, and 0.5≦alkyl halide/Mg≦10, more preferably, 1≦alkyl halide/Mg≦2.

According to another aspect of the present invention, provided is a method for olefin (co)polymerization using a Ziegler-Natta catalyst for olefin polymerization comprising transition metal compound containing aryloxy ligand and transition metal with the oxidation number of 3 from Group IV, V or VI of the Periodic Table of Elements which is prepared by the reduction of transition metal compound containing at least two aryloxy ligands and transition metal with the oxidation number of 4 or more from Group IV, V or VI of the Periodic Table.

In the method for olefin (co)polymerization of the present invention, the above-described Ziegler-Natta catalyst for olefin polymerization is used as a main catalyst.

Further, in the method for olefin (co)polymerization of the present invention, organometallic compound from Group II or III of the Periodic Table is used as a cocatalyst, and preferably used is an organo-aluminum compound such as trialkylaluminium. The alkyl groups included in the organometallic compound from Group II or III of the Periodic Table being used as a cocatalyst in the method for olefin (co)polymerization of the present invention, include the number of carbon atoms of 1-16, preferably 2-12. As an example of such organo-aluminum compound, triethylaluminum, trimethylaluminum, tri-n-propylaluminum, tri-n-butylaluminum, tri-isobutylaluminum, tri-n-hexylaluminum, tri-n-octylaluminum, tri-2-methylpentylaluminum and the like may be mentioned, and preferably triethylaluminum, tri-n-hexylaluminum, tri-n-octylaluminum and the like may be mentioned.

In the method for olefin (co)polymerization of the present invention, the molar ratio of the main catalyst and the cocatalyst used may be varied by the characteristics of each polymerization process and desired polymers. In terms of efficiency in the catalyst production process and improvement in polymerization activity, it is preferred to use the main catalyst and cocatalyst with the molar ratio of 0.5≦(Group II or III metal contained in the cocatalyst/transition metal contained in the main catalyst)≦500, in slurry process, gas-phase process or solution process, and the like. [301 According to one embodiment of the present invention, a polymerization process in the method for olefin polymerization of the present invention is carried out generally at the temperature of 40° C.-150° C., under the pressure of 15 bars or less. The polymerization is conducted by feeding monomers comprised of ethylene, and possibly other olefins, into a diluted solution such as saturated hydrocarbon solution comprising the catalyst system. In the case of not using such diluted solution, polymerization can be conducted by direct contacting monomers in gas phase with a catalyst system. Generally, the polymerization can be carried out in the presence of a chain growth inhibitor such as hydrogen.

In the method for olefin (co)polymerization of the present invention, the catalyst system may be constituted variously. For example, a main catalyst can be added to the polymerization reactor directly in the form of a solid, or in the form of a prepolymer which is prepared by prepolymerization of one or more olefins in inert liquid such as aliphatic hydrocarbon. The co-catalyst, organo-metal compound from Group II or III of the Periodic Table may be directly added to the polymerization reactor.

Hereinafter, the present invention is further described in detail through Examples and Comparative examples below, however the scope of the present invention is by no means limited by these examples with illustrative purposes.

### EXAMPLE 1

1. Preparation of Catalyst

To a 1 L 4-neck flask equipped with a mechanical stirrer, 12.7 g (0.525 mol) of metal magnesium and 1.4 g (0.005 mol) of iodine were introduced, and 450 ml of purified heptane was added thereto to form a suspension. The suspension was heated to about 70° C. 56.6 g (0.12 mol) of bis(2,6-diisopropylphenoxy)titanium dichloride dissolved in 150 ml of heptane, was added thereto, and then 84.1 ml (0.8 mol) of 1-chlorobutane was added dropwise at a constant rate. Completing the dropwise addition, it was allowed to react for further 2 hours to obtain a catalyst. The resulted catalyst was washed with a sufficient amount of hexane for 4 times, and then stored as a slurry in purified hexane. The results of the analysis of the catalyst slurry were as follows:

Total titanium content: 4.45 wt %,

Content of titanium with the oxidation number of 3 in the total titanium: 78%

2. Olefin Polymerization

To a 2 L stainless steel reactor equipped with a stirrer and a heating/cooling device, 1000 ml of purified hexane was introduced. The reactor was sufficiently purged with pure nitrogen before use. Then, to the reactor, 2 cc of 1.0M tri-n-octylaluminum (TnOA) diluted in hexane as a cocatalyst and 4.5 ml (6 mmol) of the catalyst slurry prepared in the above step 1 as a main catalyst were added. Next, the temperature of the reactor was raised to 80° C. To the reactor, hydrogen was introduced with the pressure of 66 psig, ethylene was further introduced to make the total pressure in the reactor 187 psig, and the reaction was allowed to start by stirring at 1000rpm. While supplying sufficient amount of ethylene into the reactor so as to maintain the total pressure of the reactor to 187 psig constantly during the reaction, polymerization was carried out for 1 hour. After the 1 hour of polymerization, ethanol was added to the reactor with an amount of about 10 cc to remove the catalyst activity and terminate the reaction, thereby obtaining polymers. The resulted polymers were filtered for separation and dried sufficiently to obtain 100.0 g of polyethylene.

### EXAMPLE 2

Polyethylene was prepared by the same method as in Example 1, except that, in olefin polymerization step, 2 cc of 1.0M tri-n-hexylaluminum (TnHA) diluted in hexane was used as a cocatalyst. The amount of polyethylene obtained after drying was 123.0 g.

### EXAMPLE 3

Polyethylene was prepared by the same method as in Example 1, except that, in olefin polymerization step, 2 cc of 1.0M triethylaluminum (TEA) diluted in hexane was used as a cocatalyst. The amount of polyethylene obtained after drying was 108.5 g.

### COMPARATIVE EXAMPLE 1

1. Preparation of Catalyst

To a 1 L 4-neck flask equipped with a mechanical stirrer, 12.7 g (0.525 mol) of metal magnesium and 1.4 g (0.005 mol) of iodine were introduced, and 600 ml of purified heptane was added thereto to form a suspension. The suspension was heated to about 70° C. 15.2 ml (0.056 mol) of titanium propoxide and 7.2 ml (0.065 mol) of titanium tetrachloride were added thereto, and then 84.1 ml (0.8 mol) of 1-chlorobutane was added dropwise at a constant rate. Completing the dropwise addition, it was allowed to react for further 2 hours to obtain a catalyst. The resulted catalyst was washed with a sufficient amount of hexane for 4 times, and then stored as slurry in purified hexane. The results of the analysis of the catalyst slurry were as follows:

Total titanium content: 7.3 wt %,

Content of titanium having the oxidation number of 3 in the total titanium: 85%

2. Olefin Polymerization

Polyethylene was prepared by the same method as in Example 1, except that the catalyst slurry prepared in the first step of Comparative example 1 was used as a main catalyst with an amount of 4.5 ml (6mmol). The amount of polyethylene obtained after drying was 40.0 g.

Polyethylenes prepared from Examples 1-3 and Comparative example 1 were tested for various properties thereof, and the results were set out as below.

TABLE 1

| | Tests | | | |
|---|---|---|---|---|
| | Polymerization | Melt index | Melt index | Melt flow rate |
| | activity | (2.16 kg) | (21.6 kg) | ratio (MFRR) |
| Example 1 | 6.93 | 1.35 | 53.67 | 39.76 |
| Example 2 | 8.52 | 2.43 | 99.86 | 41.09 |
| Example 3 | 7.52 | 1.18 | 45.8 | 38.81 |
| Comp. | 4.13 | 1.09 | 34.8 | 31.9 |
| Example 1 | | | | |

Note)
Unit for the polymerization activity: kg-PE/g-Ti × hour(hr) × pressure(atm)
Melt index (2.16 kg): measured according to ASTM D1238, 190° C., 10 mins., 2.16 kg
Melt index (21.6 kg): measured according to ASTM D1238, 190° C., 10 mins., 21.6 kg

Melt Flow Rate Ratio (MFRR): melt index (21.6 kg)/melt index(2.16 kg)

As seen from Table 1 above, the Ziegler-Natta catalyst prepared according to Example 1 of the present invention by introducing at least 2 aryloxy ligands into transition metal compound containing transition metal with the oxidation number of 4 or more and reducing the resulted compound with organomagnesium compound, exhibited increased polymerization activity by 70% or more as compared with the catalyst prepared from Comparative example 1 which corresponds to the conventional catalysts. Further, regarding the molecular weight distribution which is one of important characteristics in processability, it can be known that, when using the catalyst of Example 1 of the present invention to ethylene polymerization, the resulted polymer shows increased MFRR as compared with Comparative example 1, and it means that, according to Examples 1˜3, it is possible to obtain polyethylene having broader molecular weight distribution than the polyethylene from Comparative example 1.

### INDUSTRIAL APPLICABILITY

As described so far, when using the Ziegler-Natta catalyst for olefin polymerization of the present invention in olefin polymerization, wherein the catalyst comprises transition metal compound containing aryloxy ligand and transition metal with the oxidation number of 3 from Group IV, V or VI of the Periodic Table of Elements which is prepared by the reduction of transition metal compound containing at least two aryloxy ligands and transition metal with the oxidation number of 4 or more from Group IV, V or VI of the Periodic Table, it is possible to obtain olefin polymers having broader molecular weight distribution with high polymerization activity as compared with the conventional catalyst comprising transition metal compound containing transition metal with the oxidation number of 3 from Group IV of the Periodic Table.

1. A Ziegler-Natta catalyst for olefin polymerization comprising transition metal compound containing aryloxy ligand and transition metal with the oxidation number of 3 from Group IV, V or VI of the Periodic Table which is prepared by the reduction of transition metal compound containing at least two aryloxy ligands and transition metal with the oxidation number of 4 or more from Group IV, V or VI of the Periodic Table.

2. The Ziegler-Natta catalyst according to claim 1, wherein the transition metal compound containing aryloxy ligand and transition metal with the oxidation number of 3 from Group IV, V or VI of the Periodic Table of Elements is prepared by the reduction of transition metal compound containing at least two aryloxy ligands and transition metal with the oxidation number of 4 or more from Group IV, V or VI of the Periodic Table, represented by the formula of M(OAr)ₙXₐ₋ₙ (wherein M is a transition metal from Group IV, V or VI of the Periodic Table; Ar is a substituted or non-substituted aryl group having C6-C30; X is a halogen atom; n is an integer or a fraction satisfying 2<=n<=a; and a is the oxidation number of M and an integer of 4 or more), with organomagnesium compound.

3. The Ziegler-Natta catalyst according to claim 2, wherein the organomagnesium compound is represented by the formula of RₘMgX₂₋ₘ (wherein R is an alkyl having C1-C16; X is a halogen atom; m is an integer or a fraction satisfying 0<m<=2).

4. The Ziegler-Natta catalyst according to claim 2, wherein the transition metal compound containing at least two aryloxy ligands and transition metal with the oxidation number of 4 or more from Group IV, V or VI of the Periodic Table is reduced with the organomagnesium compound at the temperature of −20-150° C. with the molar ratio of 0.1<=(the transition compound containing at least two aryloxy ligands/the organomagnesium compound)<=0.5.

5. A method for olefin (co)polymerization, wherein the Ziegler-Natta catalyst according to any one of claim 1 is used as a main catalyst and organometallic compound from Group II or III of the Periodic Table is used as a cocatalyst.

6. The method according to claim 5, wherein the molar ratio of the main catalyst and the cocatalyst used is 0.5<=(Group II or III metal contained in the cocatalyst/transition metal contained in the main catalyst)<=500.

7. A method for olefin (co)polymerization, wherein the Ziegler-Natta catalyst according to claim 2 is used as a main catalyst and organometallic compound from Group II or III of the Periodic Table is used as a cocatalyst.

8. The method according to claim 7, wherein the molar ratio of the main catalyst and the cocatalyst used is 0.5<=(Group II or III metal contained in the cocatalyst/transition metal contained in the main catalyst)<=500.

9. A method for olefin (co)polymerization, wherein the Ziegler-Natta catalyst according to claim 3 is used as a main catalyst and organometallic compound from Group II or III of the Periodic Table is used as a cocatalyst.

10. The method according to claim 9, wherein the molar ratio of the main catalyst and the cocatalyst used is 0.5<=(Group II or III metal contained in the cocatalyst/transition metal contained in the main catalyst)<=500.

11. A method for olefin (co)polymerization, wherein the Ziegler-Natta catalyst according to claim 4 is used as a main catalyst and organometallic compound from Group II or III of the Periodic Table is used as a cocatalyst.

12. The method according to claim 11, wherein the molar ratio of the main catalyst and the cocatalyst used is 0.5<=(Group II or III metal contained in the cocatalyst/transition metal contained in the main catalyst)<=500.
